(19) United States
(12) Patent Application Publication
(10) Pub. No.: US 2025/0303506 A1
(43) Pub. Date: Oct. 2, 2025

(54) WELDING MACHINES FOR PIPELINES

(71) Applicant: Ritmo S.P.A., Teolo (Padova) (IT)

(72) Inventors: Renzo BORTOLI, Montegrotto Terme (Padova) (IT); Alessandro Apolinari, Cervarese Santa Croce (Padova) (IT); Giovanni Bisello, Selvazzano Dentro (Padova) (IT); Roberto La Torre, Abano Terme (Padova) (IT)

(73) Assignee: Ritmo S.P.A., Teolo (Padova) (IT)

(21) Appl. No.: 19/090,533

(22) Filed: Mar. 26, 2025

(30) Foreign Application Priority Data
Mar. 26, 2024 (IT) 102024000006649

(51) Int. Cl. B23K 37/0533; B23C 3/12; B23K 101/10; F15B 13/04; F15B 19/00; G05D 3/12

(52) U.S. Cl. CPC B23K 37/0533; B23C 3/122; F15B 13/0401; F15B 19/00; G05D 3/12; B23K 2101/10

(57) ABSTRACT

A pipeline butt welding machine has support means, a first vise assembly and a second vise assembly associated with the support means and adapted to engage respectively a first and a second tubular element to be joined by welding; at least one of the vise assemblies being movable relative to the other between a position of maximum mutual distance and a position of minimum mutual distance; the mobile vise unit being operatively connected to at least one fluid-dynamic cylinder comprising a casing and a piston slidingly housed within the casing and defining in the casing a first and a second mutually variable volume chamber. The welding machine has a fluid-dynamic circuit configured to feed fluid under pressure simultaneously to the first and second chambers and to control the motion of the movable vise assembly as a function of a pressure difference between the first and second chambers.

The present invention relates to a welding machine for pipelines, particularly for butt welding pipelines arranged substantially vertically or otherwise strongly inclined to the horizontal.

As is well known, butt welding of joints, pipes, and fittings made of thermoplastic materials, such as polypropylene (PP) and high-density polyethylene (HDPE), is a process used to join two tubular members of equal diameter and thickness by heating the respective ends, through contact with a thermal element, and subsequent pressure.

To carry out this type of welding, suitable welding machines are used to ensure the coaxiality of the tubular elements to be welded and to press them against each other with the right force, e.g. in a ramp pattern, until a welding force is reached in a predetermined time.

Such welding machines substantially comprise a machine body having a group of fixed vises and a group of moving vises; the moving vises are moved towards or away from the fixed vises by cylinders driven by a hydraulic circuit controlled by a control unit.

Although the hydraulic circuits currently on the market are designed to weld tubular elements arranged substantially horizontally, as required by international welding standards, the need frequently arises to weld tubular elements arranged substantially vertically or strongly inclined.

In the latter case, if the movable vises assembly is arranged lower than the fixed vises assembly, i.e. if the element to be welded has to be pulled upwards in some way, there is no particular difference to the case where the tubular elements to be welded are arranged horizontally.

The situation is different, however, when the movable vises assembly is placed higher up than the fixed vises assembly, i.e. when the element to be welded must somehow be “accompanied” downwards. In fact, in this case, the weight of the tubular element continually tends to bring the moving vises assembly closer to the fixed vises assembly, generating conditions for which current welding machines are not designed.

This leads to several drawbacks in use.

A first drawback is that, after heating the ends of the tubular elements with the thermo element, they must be brought into contact with an initially zero force and then this force must be increased linearly up to the welding value. The welding machines currently on the market are not able to correctly perform this phase, when the group of mobile vises is placed higher than the group of fixed vises, because the hydraulic circuit of a conventional machine allows the management of pressure control in one chamber of the cylinders at a time. This causes that, during the approach phases of the mobile vises group to the fixed vises group, the mobile tubular element is not gradually “accompanied” in contact with the fixed tubular element, generating a force peak during the welding phase which prevents the gradual increase of this force in the time set by the welding standards, and also prevents the correct force value from being reached.

From the above problem follows a second one. In fact, if the peak force generated by the impact between the tubular elements were to be greater than the force value set for the welding phase, a hysteresis problem would be triggered. This would lead to inconsistencies between the pressure supplied to the cylinders and the force actually transmitted to the moving vise assembly. If this phenomenon is not taken into account during the welding phase of the tubular elements, the force transmitted could be higher than the desired value, making the weld non-compliant with standards.

The aim of the present invention is to provide a pipeline welding machine that overcomes the drawbacks of the prior art.

Within this aim, an object of this invention is to provide a welding machine capable of welding tubular elements arranged substantially vertically, or strongly inclined with respect to the horizontal, guaranteeing a precise and controlled management of the force exerted on the ends of the tubular elements during the welding phase, even when the group of movable vises is arranged above the fixed vises assembly.

A further object of the invention is to provide a welding machine capable of controlling any hysteresis phenomena that may occur during welding.

A further object of the invention is to provide a welding machine that is flexible in use, i.e. that substantially allows use in any position.

A further object of the present invention is to provide a welding machine which, due to its special design features, is able to ensure the broadest guarantees of reliability and safety in use.

The above aim and objects, and others which will better appear hereinafter, are achieved by a welding machine for pipelines as claimed in the appended claims.

Further characteristics and advantages will become better apparent from the description of a preferred, but not exclusive, embodiment of a welding machine for pipelines according to the invention, illustrated by way of non-limiting example in the accompanying drawings:

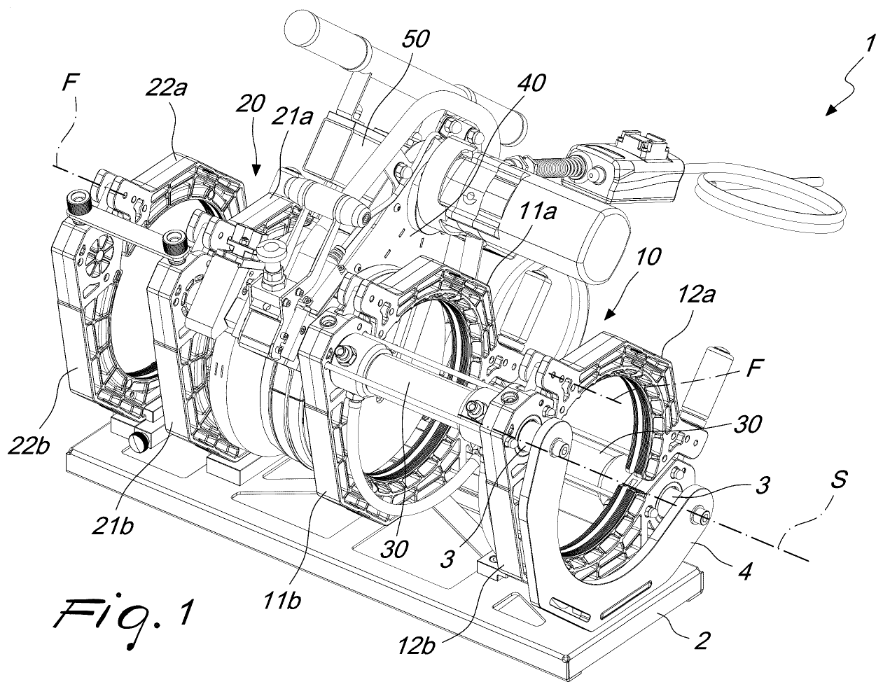

FIG. 1 is a perspective view of the welding machine according to the present invention;

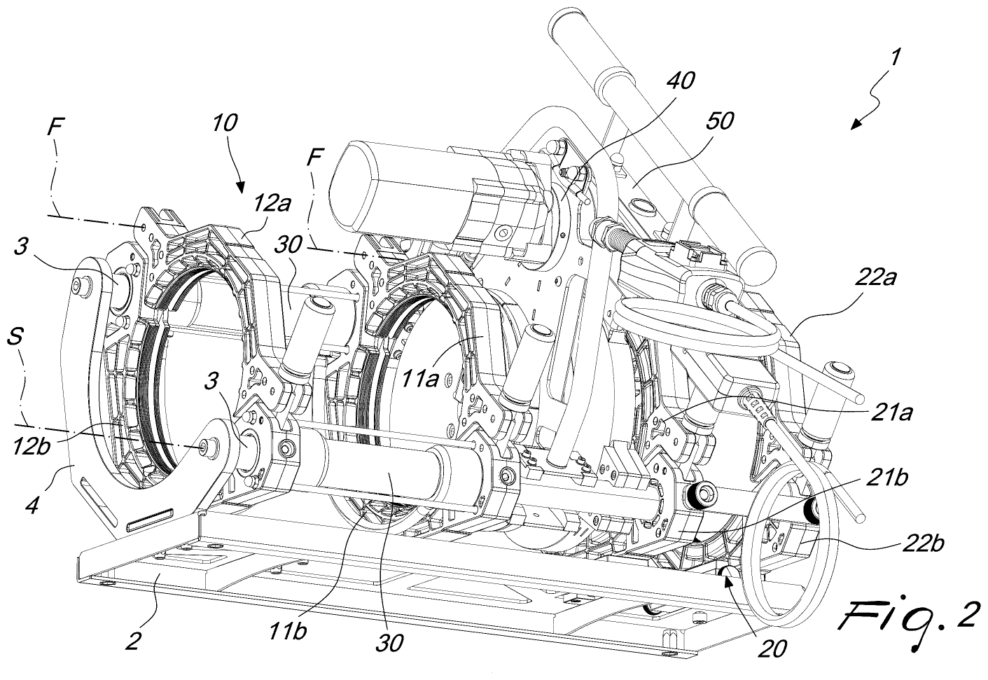

FIG. 2 is a perspective view of the opposite side of the welding machine according to the present invention;

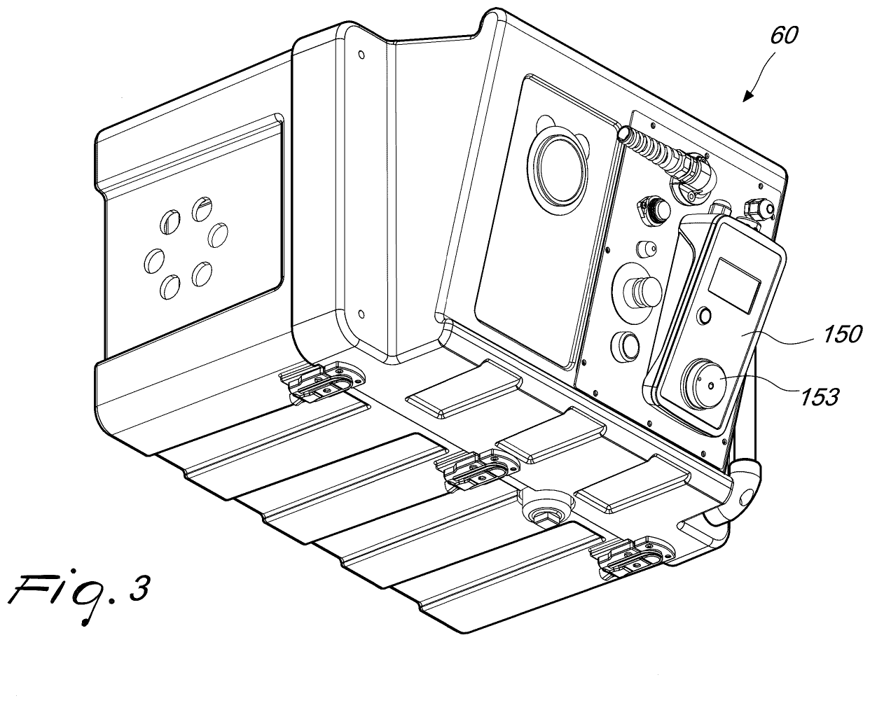

FIG. 3 is a perspective view of a component of the welding machine;

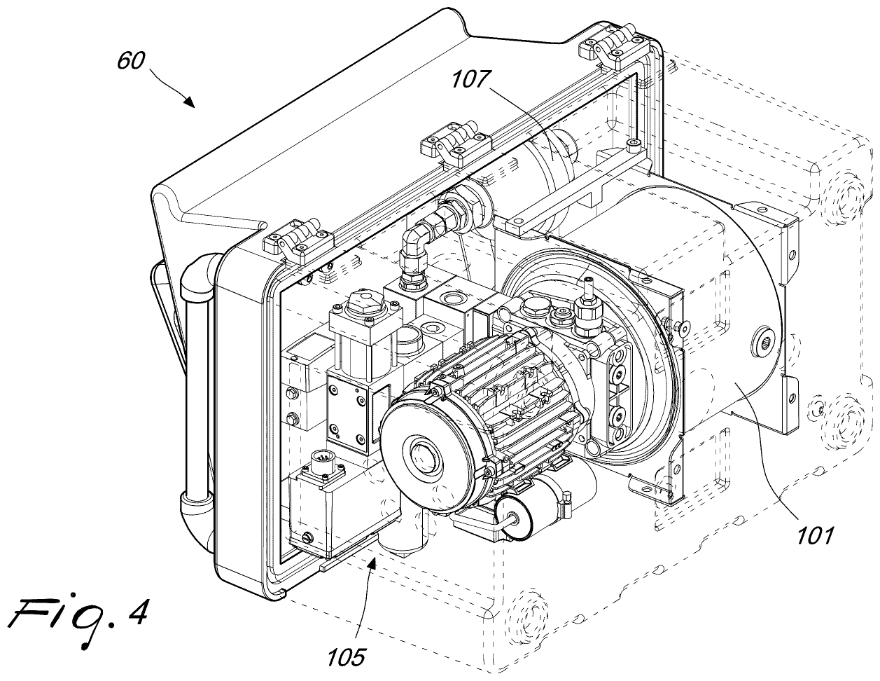

FIG. 4 is a perspective view, with parts removed for clarity, of the component of FIG. 3;

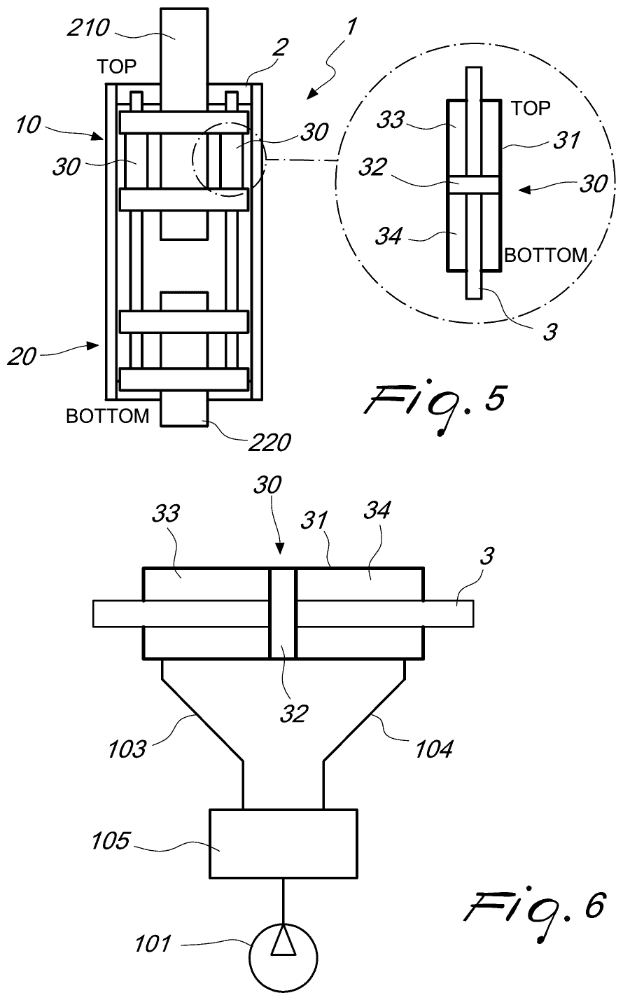

FIG. 5 is a schematic view, with parts removed for clarity, of the welding machine;

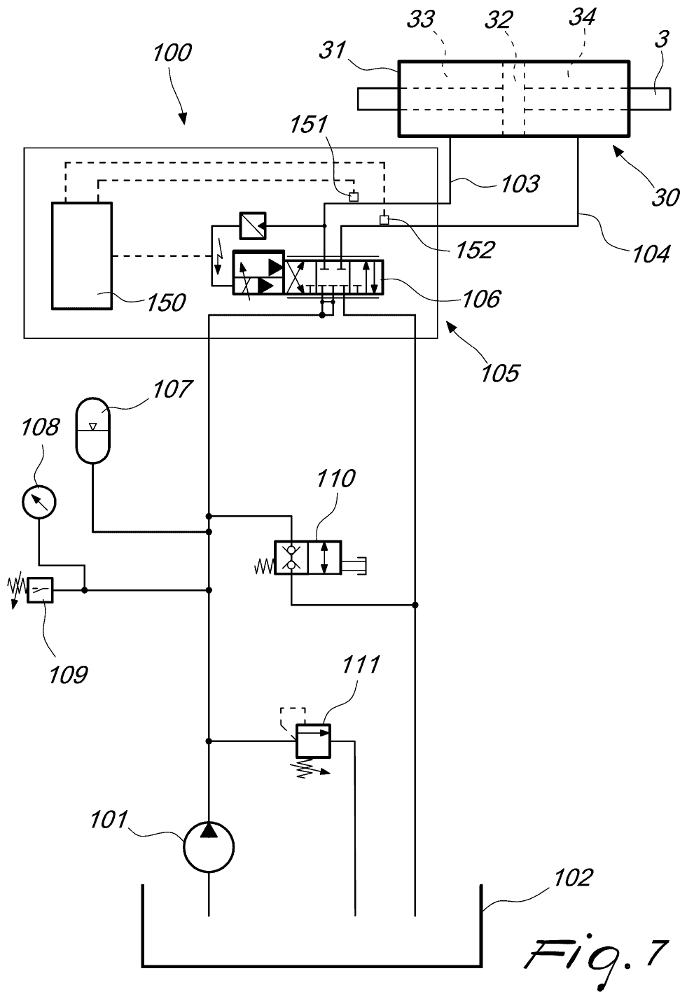

FIG. 6 schematically illustrates the operating principle of the welding machine according to the invention;

FIG. 7 is a schematic view, with parts removed for clarity, of a hydraulic circuit associated with the welding machine according to the invention.

With reference to the figures, a welding machine, globally designated by the reference number 1, according to an aspect of the invention, comprises an alignment structure including support means 2, in this case a substantially rectangular frame, to which a first vise assembly 10 and a second vise assembly 20 are associated, which are capable of respectively engaging a first tubular element 210 and a second tubular element 220 to be joined by welding.

According to this embodiment, the first vise assembly 10 comprises a first pair of vises, each formed by an upper jaw 11a, 12a hinged to a lower jaw 11b, 12b for swinging, with respect to the support means 2, about a fulcrum axis F.

Similarly, the second vise assembly 20 comprises a second pair of vises, each formed by an upper jaw 21a, 22a hinged to a lower jaw 21b, 22b for swinging, with respect to the support means 2, about the fulcrum axis F, or an axis parallel thereto.

In the present description and claims, the terms “first”, “second”, “upper”, and “lower”, are used merely to more clearly identify the components from each other and are not intended to denote an order, quantity, relative position or priority.

Both or at least one of the first and second vise assemblies 10, 20 are linearly movable in approach/retreat between a position of maximum mutual distance and a position of minimum mutual distance.

In this case, the second vise assembly 20 is permanently associated with the support media 2, while the first vise assembly 10 is smoothly associated with the support media 2 by means of adapted guide means.

According to an embodiment of the invention, said guide means comprise a pair of rods 3, preferably cylindrical, parallel to each other and arranged in order to guide a linear movement of the first vise assembly 10 with respect to the supporting means 2, along a sliding direction S. The opposite ends of the rods 3 are integral respectively with the lower jaw 21b of the second vise assembly 20 and a shaped plate 4 projecting from the supporting means 2, in diametrically opposite positions.

Advantageously, the first vise assembly 10 is operatively connected to a pair of double-acting, preferably hydraulically actuated, fluid-dynamic cylinders 30. Each fluid-dynamic cylinders 30 comprises a casing 31 and a piston 32, slidingly housed within the casing 31 and forming a first chamber 33 and a second chamber 34 of mutually variable volume, inside the casing 31. Each piston 32 is integral with a corresponding rod 3, while the opposite ends of the casings 31 are integral with the lower jaw 11b and the lower jaw 12b of the first vise assembly 10, respectively, in diametrically opposite positions. In this way, feeding fluid under pressure to the fluid-dynamic cylinders 30, makes it possible to keep the respective pistons 32 fixed while making the corresponding casings 31 slide and therefore move the first vise assembly 10 relative to the second vise assembly 20 and the support means 2.

The welding machine 1 also comprises a milling device 40, adapted to flatten and make parallel the ends of the first and second tubular element 210, 220. The welding machine 1 also comprises a heating element 50, preferably comprising a heating plate, adapted to melt the ends of the first and second tubular element 210, 220 in order to perform welding thereof. Preferably, the milling device 40 and the heating element 50 are removably associated with the welding machine 1 and can be moved relative to the first and second vise assemblies 10, 20.

According to the present invention, the fluid-dynamic cylinders 30 of the welding machine 1 are controlled by a fluid-dynamic circuit 100 comprising a pump 101, a tank 102 and lines connecting the pump 101 and the tank 102 to each fluid-dynamic cylinder 30. The fluid-dynamic circuit 100 is configured to feed fluid under pressure, preferably oil, simultaneously to the first and second chambers 33, 34 of each fluid-dynamic cylinder 30 and to optimally manage the characteristics of the motion (in particular direction, speed and force) imparted to the movable vise assembly, namely to the first vise assembly 10, as a function of the pressure difference AP=P1-P2, wherein P1 and P2 indicate the pressure in the first and second chambers 33, 34 respectively.

The fluid-dynamic cylinders 30 of the welding machine 1 are connected to two branches 103, 104 of the fluid-dynamic circuit 100. Adapted distribution means 105 are arranged along the two branches 103, 104 of the fluid-dynamic circuit 100.

The distribution means 105 are configured to distribute fluid under pressure simultaneously to the first and second chambers 33, 34 while maintaining the sum of the pressures within them, P₁+P₂, constantly equal to the maximum pressure deliverable by the pump 101.

According to an embodiment of the invention, the distribution means 105 comprise a servo valve 106 controlled by an electronic control unit 150 that supervises the operation of the welding machine 1.

Preferably, the electronic control unit 150 comprises a pressure sensor 151 for detecting the pressure P1, present in the first chamber 33, and a pressure sensor 152 for detecting the pressure P2, present in the second chamber 34. The electronic control unit 150 acquires signals emitted by the pressure sensors 151, 152, calculates the pressure difference ΔP between the first and second chambers 33, 34, and consequently controls the servo valve 106, depending on the movement (direction, speed and force) to be imparted to the first vise assembly 10.

Regarding the characteristics of the motion to be imparted to the first vise assembly 10, and the corresponding value of the pressure difference AP generated by the servo-valve 106 between the first and second chambers 33, 34, the following three situations may be verified.

If it is desired that the fluid-dynamic cylinders 30 exert a displacement force on the first vise assembly 10, sufficient to bring it to the position of maximum distance from the second vise assembly 20, the electronic control unit 150 is programmed so as to place the servo-valve 106 in a first operating condition, in which the servo-valve 106 itself generates a positive pressure difference AP between the first and second chambers 33, 34 (i.e. the servo-valve 106 causes the pressure P1 present in the first chamber 33 to be greater than the pressure P2 present in the second chamber 34).

If, on the other hand, it is desired that the fluid-dynamic cylinders 30 exert on the first vise assembly 10 a displacement force suitable to bring it to the position of minimum distance from the second vise assembly 20, the electronic control unit 150 is programmed to arrange the servo-valve 106 in a second operating condition, in which the same servo valve 106 generates a negative pressure difference AP between the first and second chambers 33, 34 (i.e., the servo valve 106 causes the pressure P1 present in the first chamber 33 to be less than the pressure P2 present in the second chamber 34).

If it is desired that the fluid-dynamic cylinders 30 do not exert any displacement force on the first vise assembly 10, the electronic control unit 150 is programmed so as to place the servo-valve 106 in a third operating condition, in which the servo-valve 106 itself does not generate any pressure difference AP between the first and second chambers 33, 34 (i.e., the servo-valve 106 causes the pressure P1 present in the first chamber 33 to be equal to the pressure P2 present in the second chamber 34).

Advantageously, the fluid-dynamic circuit 100 also comprises accumulation means 107, measuring means, consisting of a pressure gauge 108 and a transducer 109, and safety means, consisting of a relief valve 110 and a pressure relief valve 111.

According to an embodiment of the invention, the electronic control unit 150 is housed in a control unit 60 which also accommodates part of the fluid-dynamic circuit 100 and which supports at least one manual control 153, namely an encoder, configured to allow a user to place the servo-valve 106 in at least the first, second or third operating condition and, thus, change the value of the pressure difference AP between the first and second chambers 33, 34.

The operation of the butt welding machine for pipelines according to the invention is substantially as follows.

Once the first tubular element 210 is correctly fastened to the first vise assembly 10 and the second tubular element 220 is correctly fastened to the second vise assembly 20, in order to approach/remove the two tubular elements 210, 220 it is sufficient to interact, by means of the manual control 153, with the electronic control unit 150 that controls the servo-valve 106, which in turn modifies the value of the pressure difference ΔP between the first and second chambers 33, 34 of the fluid-dynamic cylinders 30. In fact, by modifying the value of the pressure difference ΔP=P₁-P₂, the pressure P₁ present in the first chamber 33 and the pressure P₂ present in the second chamber 34 can consequently be varied, provided that the sum of the pressures within them, P₁+P₂, is constantly equal to the maximum pressure that can be delivered by the pump 101.

Assuming, for example, that the first and second vise assemblies 10, 20 are initially in the position of maximum distance from each other, to bring the first vise assembly 10 closer to the second vise assembly 20, for example to prepare the surfaces to be welded of the first and second tubular elements 210, 220 by means of the milling device 40, or to heat these surfaces by contact with the heating element 50, or again to weld the surfaces that have just been heated, one can act in different ways depending on the different working conditions and specific requirements.

In the case in which the first and second tubular elements 210, 220 are arranged horizontally, or are arranged vertically, or in any case strongly inclined with respect to the horizontal, with the first vise assembly 10 arranged at the bottom and the second vise assembly 20 arranged at the top, in order to bring the first vise assembly 10 closer to the second vise assembly 20, it is sufficient to arrange the servo-valve 106 in the second operating condition, acting on the manual control 153. In this case, the servo-valve 106 generates a negative pressure difference AP, i.e., it receives the fluid at maximum pressure from the pump 101 and distributes it to the fluid-dynamic cylinders 30 so that the pressure P1 present in the first chamber 33 is lower than the pressure P2 present in the second chamber 34; from this situation of pressure imbalance between the two chambers 33, 34, a displacement force originates and brings the first vise assembly 10 to the position of minimum distance from the second vise assembly 20.

In the case in which the first and the second tubular element 210, 220 are arranged vertically, or in any case strongly inclined with respect to the horizontal, with the first vise assembly 10 arranged at the top and the second vise assembly unit 20 arranged at the bottom, in order to bring the first vise assembly 10 closer to the second vise assembly 20, in determining the operating condition in which to arrange the servo-valve 106, it is necessary to take into account the fact that the weight of the first vise assembly 10 is also encumbered by the weight of the first tubular element 210, or one of its components, which in this situation already in itself tends to bring the two vise assemblies 10, 20 closer together. In this case, therefore, in addition to the second operating condition seen above, the servo valve 106 can also be arranged in the first or third operating condition.

In particular, if the servo-valve 106 is arranged in the first operating condition, it generates a positive pressure difference AP, i.e. it receives the fluid at the maximum pressure from the pump 101 and distributes it to the fluid-dynamic cylinders 30 so that the pressure P1 present in the first chamber 33 is higher than the pressure P2 present in the second chamber 34; from this situation of pressure imbalance between the two chambers 33, 34, a displacement force originates which tends to bring the first vise assembly 10 to the position of maximum distance from the second vise assembly 20. Consequently, in this situation, the displacement force exerted by the fluid-dynamic cylinders 30 on the first vise assembly 10 goes to counteract the weight of the first tubular element 210, or one of its components; in this way, by appropriately acting on the manual control 153, it is possible to slow down the approach speed of the first vise assembly 10 to the second vise assembly 20 and provide the correct welding force.

On the other hand, if the servo-valve 106 is arranged in the third operating condition, it does not generate any pressure difference AP, i.e. it receives the fluid at the maximum pressure from the pump 101 and distributes it to the fluid-dynamic cylinders 30 so that the pressure P1 present in the first chamber 33 is equal to the pressure P2 present in the second chamber 34; as a result of the pressure equilibrium situation created between the two chambers 33, 34, the fluid-dynamic cylinders 30 do not exert any displacement force on the first vise assembly 10. In this case, therefore, the first vise assembly 10 is substantially passive and only the weight of the first tubular element 210, or one of its components, acts on it, which in this situation already in itself tends to bring the two vise assemblies 10, 20 closer together.

In the opposite case, in which the first vise assembly 10 is to be moved away from the second vise assembly 20, it is possible to act in a substantially similar but opposite manner to that described above. Once again, depending on different working conditions and specific requirements, the servo valve 106 can be operated in different ways.

In the case in which the first and second tubular elements 210, 220 are arranged horizontally, or are arranged vertically, or in any case are strongly inclined with respect to the horizontal, with the first vise assembly 10 arranged at the top and the second vise assembly 20 arranged at the bottom, in order to move the first vise assembly 10 away from the second vise assembly 20, it is sufficient to arrange the servo-valve 106 in the first operating condition, acting on the manual control 153. In this case, in fact, the servo-valve 106 generates a positive pressure difference AP, i.e. it receives the fluid at maximum pressure from the pump 101 and distributes it to the fluid-dynamic cylinders 30 so that the pressure P1 present in the first chamber 33 is higher than the pressure P2 present in the second chamber 34; from this situation of pressure imbalance between the two chambers 33, 34, a displacement force originates which tends to bring the first vise assembly 10 to the position of maximum distance from the second vise assembly 20.

On the other hand, in the case in which the first and the second tubular element 210, 220 are arranged vertically, or in any case strongly inclined with respect to the horizontal, with the first vise assembly 10 arranged at the bottom and the second vise assembly 20 arranged at the top, in order to move the first vise assembly 10 away from the second vise assembly 20, in determining the operating condition in which to arrange the servo-valve 106, it is necessary to take into account the fact that the weight of the first vise assembly 10 is also encumbered by the weight of the first tubular element 210, or one of its components, which already in itself in this situation tends to move the two vise assemblies 10, 20 apart. In this case, therefore, in addition to the first operating condition seen above, the servo-valve 106 can also be arranged in the second or third operating condition.

If the servo-valve 106 is arranged in the second operating condition, it generates a negative pressure difference AP, i.e. it receives the fluid at the maximum pressure from the pump 101 and distributes it to the fluid-dynamic cylinders 30 so that the pressure P1 present in the first chamber 33 is lower than the pressure P2 present in the second chamber 34; from this situation of pressure imbalance between the two chambers 33, 34, a displacement force originates which tends to bring the first vise assembly 10 to the position of minimum distance from the second vise assembly 20. Consequently, the displacement force exerted by the fluid-dynamic cylinders 30 on the first vise assembly 10 goes, in this situation, to counteract the weight of the first tubular element 210, or one of its components; in this way, it is possible, if necessary, to slow down the speed of the movement of the first vise assembly 10 away from the second vise assembly 20, by appropriately acting on the manual control 153.

On the other hand, if the servo-valve 106 is arranged in the third operating condition, it does not generate any pressure difference AP, i.e. it receives the fluid at the maximum pressure from the pump 101 and distributes it to the fluid-dynamic cylinders 30 so that the pressure P1 present in the first chamber 33 is equal to the pressure P2 present in the second chamber 34; as a result of the pressure equilibrium situation created between the two chambers 33, 34, the fluid-dynamic cylinders 30 do not exert any displacement force on the first vise assembly 10. In this case, therefore, the first vise assembly 10 is substantially passive and only the weight of the first tubular element 210, or one of its components, acts on it, which already in itself tends to displace the two vise assemblies 10, 20.

It should be noted, however, that the action of moving the first vise assembly 10 away from the second vise assembly 20 is less critical than the approach action, since even if the first vise assembly 10 were to bear the weight of the first tubular element 210, or one of its components, there would be no risk of distorting the welding force in this case.

In practice, it has been found that the invention achieves its aims and objects by providing a welding machine for pipelines that allows tubular elements arranged substantially vertically, or in any case strongly inclined with respect to the horizontal, to be welded according to the intended standard, even when the movable vise assembly is arranged above the fixed vise assembly.

In fact, the welding machine according to the invention allows the weight force of the tubular element clamped to the movable vise assembly to be managed in a gradual manner, in both directions of movement (approaching and/or moving away from/to the fixed vise assembly), guaranteeing the correct transmission of force in all phases of welding.

Also, the welding machine according to the invention makes it possible to control any hysteresis phenomena that may occur during welding.

This application claims the priority of Italian Patent Application No. 102024000006649, filed on Mar. 26, 2024, the subject matter of which is incorporated herein by reference.

1. A welding machine for pipelines, comprising support means, a first vise assembly and a second vise assembly associated with said support means; said first and second vise assemblies being configured to engage respectively a first and a second tubular element to be joined by welding; at least one of said first and second vise assemblies being movable relative to each other between a position of maximum mutual distance and a position of minimum mutual distance; said movable vise assembly being operatively connected to at least one fluid-dynamic cylinder comprising a casing and a piston slidably housed within said casing and forming a first and a second chamber in said casing; said first and second chambers having a mutually variable volume; said welding machine comprising a fluid-dynamic circuit configured to feed pressurized fluid simultaneously to said first and second chambers and to control the motion of said movable vise assembly according to a pressure difference between said first and second chambers.

2. The welding machine according to claim 1, wherein said fluid-dynamic circuit comprises a pump fluidically connected to distribution means of fluid under pressure simultaneously with said first and second chambers; the sum of the pressures within said first and second chambers being constantly equal to the maximum pressure deliverable by said pump.

3. The welding machine according to claim 2, wherein said distribution means comprises a servo valve electrically connected to an electronic control unit supervising the operation of said welding machine.

4. The welding machine according to claim 3, wherein said electronic control unit comprises pressure sensors configured to detect the pressure within said first and second chambers.

5. The welding machine according to claim 3, wherein said electronic control unit is programmed to arrange said servo valve in a first operating condition, wherein said servo valve generates a positive pressure difference between said first and second chambers, if said at least one fluid-dynamic cylinder is configured to exert on said movable vise assembly a displacement force suitable to bring it to said position of maximum mutual distance.

6. The welding machine according to claim 3, wherein said electronic control unit is programmed to arrange said servo valve in a second operating condition, wherein said servo valve generates a negative pressure difference between said first and second chambers, if said at least one fluid-dynamic cylinder has to be configured to exert on said movable vise assembly a displacement force suitable to bring it to said position of minimum mutual distance.

7. The welding machine according to claim 3, wherein said electronic control unit is programmed to arrange said servo valve in a third operating condition, wherein said servo valve does not generate any pressure difference between said first and second chambers, if said at least one fluid-dynamic cylinder has to be configured to exert no displacement force on said movable vise assembly.

8. The welding machine according to claim 3, wherein said electronic control unit comprises at least one manual control for a user, configured to allow said user to arrange said servo valve at least in said first, second and third operating conditions and consequently modify said pressure difference between said first and second chambers.

9. The welding machine according to claim 3, wherein said electronic control unit is programmed to modulate the speed and displacement force of said movable vise unit according to the absolute value set for said pressure difference between said first and second chambers.

10. The welding machine according to claim 1, comprising two fluid-dynamic cylinders operatively connected to said movable vise assembly.

11. The welding machine according to claim 2, wherein said fluid-dynamic circuit comprises a tank, accumulation means and measuring means and safety fluidically connected to said pump.

12. The welding machine according to claim 1, comprising a milling device for the ends to be welded of said first and second tubular elements; said milling device being removably associated to said support means.

13. The welding machine according to claim 1, comprising a heating element for welding said welding ends of said first and second tubular elements; said heating element being removably associated with said support means.
